(19) United States
(12) Patent Application Publication
(10) Pub. No.: US 2020/0104889 A1
(43) Pub. Date: Apr. 2, 2020

(54) SYSTEMS AND METHODS FOR PRICE ESTIMATION USING MACHINE LEARNING TECHNIQUES

(71) Applicant: BEIJING DIDI INFINITY TECHNOLOGY AND DEVELOPMENT CO., LTD., Beijing (CN)

(72) Inventors: Ziteng WANG, Beijing (CN); Xiaowei ZHONG, Beijing (CN); Fanlin MENG, Beijing (CN); Yashu LIU, Beijing (CN); Zheng WANG, Beijing (CN)

(73) Assignee: BEIJING DIDI INFINITY TECHNOLOGY AND DEVELOPMENT CO., LTD., Beijing (CN)

(21) Appl. No.: 16/699,864

(22) Filed: Dec. 2, 2019

Related U.S. Application Data
(63) Continuation of application No. PCT/CN2017/087223, filed on Jun. 5, 2017.

(51) Int. Cl. G06Q 30/02; G06Q 50/30; G06Q 10/08; G06N 20/00

(52) U.S. Cl. CPC G06Q 30/0283; G06N 20/00; G06Q 10/08355; G06Q 50/30

(57) ABSTRACT

A system may include at least one computer-readable storage medium including a set of instructions for providing an on-demand service; and at least one processor in communication with the computer-readable storage medium. When executing the set of instructions, the at least one processor may be directed to: receive a service request from a user terminal; determine at least one route for the service request; and determine an estimated price for the service request based on the at least one route and at least one price estimation model. In some embodiments, to determine the estimated price, the processor may further be directed to: extract one or more characteristics of the service request based on the route; and process the characteristics of the service request using the price estimation model.

### CROSS-REFERENCE TO RELATED APPLICATION

This application is a continuation of International Application No. PCT/CN2017/087223, filed on Jun. 5, 2017, the entire contents of which are incorporated herein by reference.

### TECHNICAL FIELD

The present disclosure generally relates to machine learning. More particularly, the present disclosure relates to methods, systems, and media for estimating prices for transportation services using machine learning techniques.

### BACKGROUND

On-demand services, such as online ridesharing services and delivery services, have become increasingly popular because of their convenience. A service platform that provides such services may need to process a high volume of complex data and conduct a massive amount of computation to automatically process and fulfill user requests. To provide scalable and real-time services to millions of users, such a service platform may need to perform the processing and computation using pattern recognition techniques, machine learning techniques, data mining techniques, predictive analytics, user behavior analytics, cloud computing techniques, and other computational techniques.

### SUMMARY

According to an aspect of the present disclosure, a system may include at least one computer-readable storage medium including a set of instructions for providing an on-demand service; and at least one processor in communication with the computer-readable storage medium. When executing the set of instructions, the at least one processor may be directed to: receive a service request from a user terminal; determine at least one route for the service request; and determine an estimated price for the service request based on the at least one route and at least one price estimation model. In some embodiments, to determine the estimated price, the processor may further be directed to: extract one or more characteristics of the service request based on the route; and process the characteristics of the service request using the price estimation model.

In some embodiments, the processor may be further directed to: obtain historical order information and traffic information related to at least one historical order; determine a plurality of historical actual prices based on the historical order information; determine a plurality of historical estimated prices corresponding to the historical actual prices according to at least one of the traffic information and the historical order information; and generate the at least one price estimation model based on the plurality of historical actual prices and the plurality of historical estimated prices.

In some embodiments, the estimated price may include at least one of a price or a price range.

In some embodiments, to determine the estimated price for the service request, the processor may be further directed to process data about the at least one route and at least one historical order related to a user using the price estimation model.

In some embodiments, to determine the historical estimated prices corresponding to the historical actual prices, the processor may be further directed to: classify the historical actual prices into a plurality of first sets based on at least one of the traffic information and the historical order information; determine a first plurality of average values of the historical actual prices for the first sets; and determine the historical estimated prices based on the first plurality of average values.

In some embodiments, to determine the historical estimated prices corresponding to the historical actual prices, the processor may be further directed to: determine a plurality of residuals for the first sets, wherein the residuals represent differences between the historical actual prices and the historical estimated prices; and classify the residuals into a plurality of second sets based on at least one of the traffic information or the historical order information.

In some embodiments, to determine the historical estimated prices corresponding to the historical actual prices, the processor may be further directed to: determine a second plurality of average values of the residuals for the second sets; and determine the historical estimated prices based on the first plurality of average values and the second plurality of average values.

In some embodiments, the at least one processor may be further directed to: analyze a rough estimated price and an actual price for each of a plurality of historical orders related to the historical order information; determine a minimum coefficient and a maximum coefficient based on the analysis; and determine a maximum estimated price and a minimum estimated price for each of the historical orders.

In some embodiments, to generate the at least one price estimation model, the at least one processor may be further directed to: generate a first price estimation model based on the minimum estimated price; and generate a second price estimation model based on the maximum estimated price.

In some embodiments, the traffic information may include at least one of information about at least one traffic light, a distance, a latitude and a longitude of a pick-up location, or a number of links of a route.

In some embodiments, the price estimation model may include a gradient boosting decision tree (GBDT) model.

According to another aspect of the present disclosure, a method for providing an on demand service may include: receiving a service request from a user terminal; determining at least one route for the service request; and determining an estimated price for the service request based on the at least one route and at least one price estimation model. In some embodiments, determining the estimated price may include: extracting one or more characteristics of the service request based on the route; and processing the characteristics of the service request using the price estimation model.

In some embodiments, the method may further include determining at least one route relating to a service request; and determining an estimated price for the service request based on the at least one route and the price estimation model.

In some embodiments, determining the estimated price for the service request may include processing data about the at least one route and at least one historical order related to a user using the price estimation model.

In some embodiments, determining the historical estimated prices corresponding to the historical actual prices may include: classifying the historical actual prices into a plurality of first sets based on at least one of the traffic information and the historical order information; determining a first plurality of average values of the historical actual prices for the first sets; and determining the historical estimated prices based on the first plurality of average values.

In some embodiments, determining the historical estimated prices corresponding to the historical actual prices may further include: determining a plurality of residuals for the first sets, wherein the residuals represent differences between the historical actual prices and the historical estimated prices; and classifying the residuals into a plurality of second sets based on at least one of the traffic information or the historical order information.

In some embodiments, determining the historical estimated prices corresponding to the historical actual prices may further include: determining a second plurality of average values of the residuals for the second sets; and determining the historical estimated prices based on the first plurality of average values and the second plurality of average values.

In some embodiments, the method may further include: analyzing a rough estimated price and an actual price for each of a plurality of historical orders related to the historical order information; determining a minimum coefficient and a maximum coefficient based on the analysis; and determining a maximum estimated price and a minimum estimated price for each of the historical orders.

In some embodiments, generating the at least one price estimation model may include: generating a first price estimation model based on the minimum estimated price; and generating a second price estimation model based on the maximum estimated price.

According to another aspect of the present disclosure, a non-transitory machine-readable storage medium may include instructions that, when accessed by at least one processor of an online on-demand service platform, causes the at least one processor to: receive a service request from a user terminal; determine at least one route for the service request; and determine an estimated price for the service request based on the at least one route and at least one price estimation model. In some embodiments, to determine the estimated price, the processor may further be directed to: extract one or more characteristics of the service request based on the route; and process the characteristics of the service request using the price estimation model.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is a block diagram illustrating an exemplary on-demand service system according to some embodiments of the present disclosure.

FIG. 2 is a schematic diagram illustrating exemplary hardware and software components of a computing device according to some embodiments of the present disclosure.

FIG. 3 is a block diagram illustrating an exemplary processing engine according to some embodiments of the present disclosure.

FIG. 4 is a flowchart illustrating an exemplary process of price estimation according to some embodiments of the present disclosure.

FIG. 5 is a flowchart illustrating an exemplary process of preprocessing historical order information according to some embodiments of the present disclosure.

FIG. 6 is a schematic diagram illustrating an example of a model that can be used to preprocess historical order information according to some embodiments of the present disclosure.

FIG. 7 is a flowchart illustrating an exemplary process of generating a price estimation model according to some embodiments of the present disclosure.

FIG. 8 is a schematic diagram of an example of a data structure for classifying historical orders according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

On-demand transportation services, such as ridesharing services, have become more and more popular. When a server of an online transportation service receives a service request (e.g., a request for ridesharing) from a requester via a user terminal, the server can provide the user with suggested routes and estimated prices. Prior solutions of price estimation utilize a formula to estimate a price of an order. For example, conventional transportation services determined an estimated price by multiplying an estimated distance and/or an estimated time of a suggested route related to an order by a rate. But the actual price or the order may be influenced by a plurality of factors, such as an actual route that may be different from the suggested route, an actual time consumed to fulfil the order, actual traffic conditions, etc. As such, the prior solutions cannot provide accurate price estimation. Aspects of the present disclosure solve the above-mentioned deficiencies by providing mechanisms (e.g., methods, systems, media, etc.) for price estimation and/or optimization using machine learning techniques.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawing(s), all of which form a part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may or may not be implemented in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to scheduling vehicles, it should also be understood that this is only one exemplary embodiment. The system or method of the present disclosure may be applied to any other kind of on-demand service. For example, the system or method of the present disclosure may be applied to different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system that applies management and/or distribution, for example, a system for sending and/or receiving an express. The application scenarios of the system or method of the present disclosure may include a webpage, a plug-in of a browser, a client terminal, a custom system, an internal analysis system, an artificial intelligence robot, or the like, or any combination thereof.

The term “passenger,” “requester,” “service requester,” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a passenger, a driver, an operator, or the like, or any combination thereof. In the present disclosure, “passenger” and “passenger terminal” may be used interchangeably, and “driver” and “driver terminal” may be used interchangeably.

The term “request” in the present disclosure refers to a request that may be initiated by a passenger, a requester, a service requester, a customer, a driver, a provider, a service provider, a supplier, or the like, or any combination thereof. The request may be accepted by any one of a passenger, a requester, a service requester, a customer, a driver, a provider, a service provider, or a supplier. The request may be chargeable, or free. The term “order” in the present disclosure refers to an intention that both a passenger (or a requester, a service requester, a customer, etc.) and a driver (or a provider, a service provider, or a supplier, etc.) show agreement of the request.

The position and/or the travel starting point in the present disclosure may be acquired by positioning technology embedded in the passenger terminal. The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure.

An aspect of the present disclosure relates to online systems and methods for estimating a price in response to a service request. According to the present disclosure, the systems and methods may determine an estimated price for the service request. The estimated price may include a value and/or a range of values (also referred to as the “price range”).

It should be noted that online on-demand transportation service, such as online taxi hailing, is a new form of service rooted only in post-Internet era. It provides technical solutions to users that could raise only in post-Internet era. In pre-Internet era, when a user hails a taxi on street, the taxi request and acceptance occur between the passenger and the taxi driver. In general, the taxi driver may provide an estimated price to the passenger according to his/her experience. However, the estimated price may be different from a price generated by a taximeter system. An online taxi system allows the service requester to reserve a service and distribute the reservation to a service provider (e.g., taxi) distance away from the user. The user and the service provider may both receive an estimated price determined by a price estimation system according to the reservation. Therefore, through Internet, the online on-demand transportation systems may provide a much more efficient transaction platform for the users and the service providers that may never met in a traditional pre-Internet transportation service system. The price estimation provides an efficient service for both requesters and service providers.

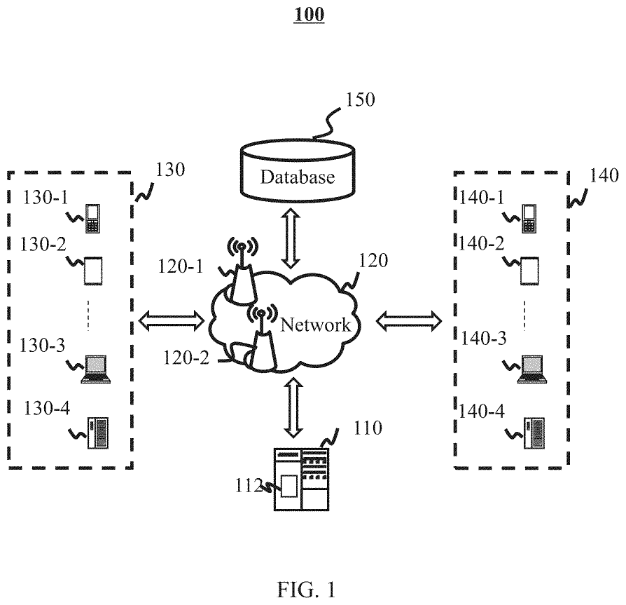

FIG. 1 is a block diagram illustrating an exemplary on-demand service system 100 according to some embodiments of the present disclosure. For example, the on-demand service system 100 may be an online transportation service platform for transportation services such as taxi hailing, chauffeur service, express car, carpool, bus service, driver hire and shuttle service. The on-demand service system 100 may include a server 110, a network 120, a passenger terminal 130, a driver terminal 140, and a database 150. The server 110 may include a processing engine 112.

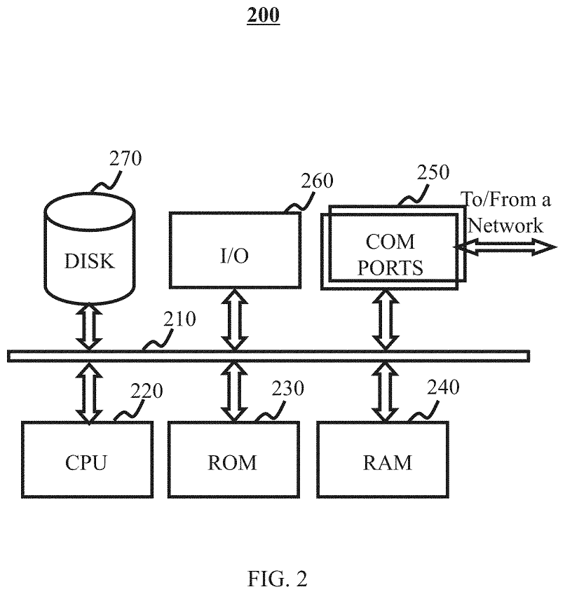

The server 110 may be configured to process information and/or data relating to a service request. For example, the server 110 may receive a service request from a passenger terminal 130, and process the request to assign a driver terminal 140 to provide service for the user of the passenger terminal 130. In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in passenger terminal 130, driver terminal 140, and/or database 150 via network 120. As another example, the server 110 may be directly connected to the passenger terminal 130, the driver terminal 140, and/or the database 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device having one or more components illustrated in FIG. 2 in the present disclosure.

In some embodiments, the server 110 may include a processing engine 112. The processing engine 112 may process information and/or data relating to the service request to perform one or more functions described in the present disclosure. For example, the processing engine 112 may receive a service request from the passenger terminal 130, and/or generate an estimated price for the service request. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the system 100 (e.g., the server 110, the passenger terminal 130, the driver terminal 140, and the database 150) may send and/or receive information and/or data to/from other component(s) in the system 100 via the network 120. For example, the server 110 may obtain/acquire service request from the passenger terminal 130 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, a global system for mobile communications (GSM) network, a code-division multiple access (CDMA) network, a time-division multiple access (TDMA) network, a general packet radio service (GPRS) network, an enhanced data rate for GSM evolution (EDGE) network, a wideband code division multiple access (WCDMA) network, a high speed downlink packet access (HSDPA) network, a long term evolution (LTE) network, a user datagram protocol (UDP) network, a transmission control protocol/Internet protocol (TCP/IP) network, a short message service (SMS) network, a wireless application protocol (WAP) network, a ultra wide band (UWB) network, an infrared ray, or the like, or any combination thereof. In some embodiments, the server 110 may include one or more network access points. For example, the server 110 may include wired or wireless network access points such as base stations and/or internet exchange points 120-1, 120-2, . . . , through which one or more components of the system 100 may be connected to the network 120 to exchange data and/or information.

The passenger terminal 130 may be used by a passenger to request an on-demand service. For example, a user of the passenger terminal 130 may use the passenger terminal 130 to send a service request for himself/herself or another user, or receive service and/or information or instructions from the server 110. In some embodiments, the term “user” and “passenger terminal” may be used interchangeably.

In some embodiments, the passenger terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the motor vehicle 130-4 may include an onboard computer, an onboard television, etc. Merely by way of example, the passenger terminal 130 may include a controller (e.g., a remote-controller).

In some embodiments, the passenger terminal 130 may be a device with positioning technology for locating the position of the user and/or the passenger terminal 130. In some embodiments, the passenger terminal 130 may communicate with other positioning device to determine the position of the user, and/or the passenger terminal 130. In some embodiments, the passenger terminal 130 may send positioning information to the server 110.

The driver terminal 140 may be used by a driver to communicate with the server 100 and the passenger terminal 130. In some embodiments, the driver terminal 140 may be a terminal that manage and/or control at least one vehicle. For example, the driver terminal 140 may be a platform that control several vehicles. In some embodiments, the driver terminal 140 may be similar to, or the same device as the passenger terminal 130.

The database 150 may store data and/or instructions. In some embodiments, the database 150 may store data obtained/acquired from the passenger terminal 130 and/or the driver terminal 140. In some embodiments, the database 150 may store data and/or instructions that the server 110 may execute or use to perform exemplary methods described in the present disclosure. In some embodiments, the database 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the database 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the database 150 may be connected to the network 120 to communicate with one or more components in the system 100 (e.g., the server 110, the passenger terminal 130, the driver terminal 140, etc.). One or more components in the system 100 may access the data or instructions stored in the database 150 via the network 120. In some embodiments, the database 150 may be directly connected to or communicate with one or more components in the system 100 (e.g., the server 110, the passenger terminal 130, the driver terminal 140, etc.). In some embodiments, the database 150 may be part of the server 110.

In some embodiments, one or more components in the system 100 (e.g., the server 110, the passenger terminal 130, the driver terminal 140, etc.) may have a permission to access the database 150. In some embodiments, one or more components in the system 100 may read and/or modify information related to the passenger, driver, and/or the public when one or more conditions are met. For example, the server 110 may read and/or modify one or more users' information after a service. As another example, the driver terminal 140 may access information related to the passenger when receiving a service request from the passenger terminal 130, but the driver terminal 140 may not modify the relevant information of the passenger.

In some embodiments, information exchanging of one or more components in the system 100 may be achieved by way of requesting a service. The object of the service request may be any product. In some embodiments, the product may be a tangible product, or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

FIG. 2 is a schematic diagram illustrating exemplary hardware and software components of a computing device 200 on which the server 110, the passenger terminal 130, and/or the driver terminal 140 may be implemented according to some embodiments of the present disclosure. For example, the processing engine 112 may be implemented on the computing device 200 and configured to perform functions of the processing engine 112 disclosed in this disclosure.

The computing device 200 may be a special purpose computer in some embodiments. The computing device 200 may be used to implement an on-demand system for the present disclosure. The computing device 200 may implement any component of the on-demand service as described herein. In FIGS. 1-2, only one such computer device is shown purely for convenience purposes. One of ordinary skill in the art would understood at the time of filing of this application that the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a central processing unit (CPU, or processor) 220, in the form of one or more processors, for executing program instructions. The exemplary computer platform may include an internal communication bus 210, a program storage and a data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, the RAM 240, and/or other type of non-transitory storage medium to be executed by the CPU/processor 220. The methods and/or processes of the present disclosure may be implemented as the program instructions. The computing device 200 may also include an I/O component 260, supporting input/output between the computer and other components therein such as a user interface element 280. The computing device 200 may also receive programming and data via network communications.

Merely for illustration, only one CPU/processor 220 is described in the computing device 200. However, it should be note that the computing device 200 in the present disclosure may also include multiple CPUs/processors, thus operations and/or method steps that are performed by one CPU/processor 220 as described in the present disclosure may also be jointly or separately performed by the multiple CPUs/processors. For example, if in the present disclosure the CPU/processor 220 of the computing device 200 executes both step A and step B, it should be understood that step A and step B may also be performed by two different CPUs/processors jointly or separately in the computing device 200 (e.g., the first processor executes step A and the second processor executes step B, or the first and second processors jointly execute steps A and B).

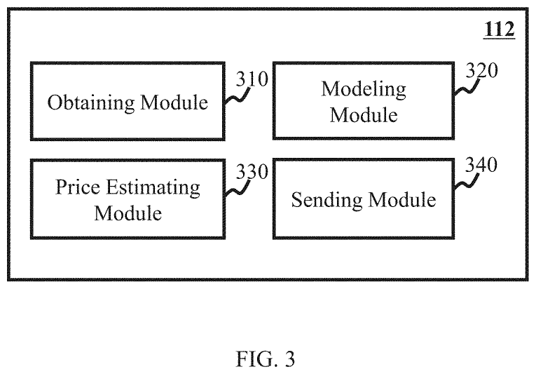

FIG. 3 is a block diagram illustrating an exemplary processing engine 112 according to some embodiments of the present disclosure. The processing engine 112 may include an obtaining module 310, a modeling module 320, a price estimating module 330, and a sending module 340. The modules may include hardware circuitry of all or part of the processing engine 112. The modules may also be implemented as an application or set of instructions read and executed by the processing engine 112. Further, the modules may be a combination of the hardware circuitry and the application/instructions. For example, the modules may be the part of the processing engine 112 when the processing engine 112 is executing the application/set of instructions.

The obtaining module 310 may be configured to obtain information from a user device (e.g., the passenger terminal 130, the driver terminal 140, etc.), the database 150, and/or any other device. The information may include any information related to the user device. For example, the obtaining module 310 may obtain positioning information related to the user device. The positioning information may include, for example, Wi-Fi data, GPS signals, etc. The positioning information can include information about one or more locations of the user device. As another example, the information can include information about one or more orders, such as information related to one or more current orders (also referred to as the “current order information”), information related to one or more historical orders (also referred to as the “historical order information”), etc. A current order may include an order that is to be fulfilled. A historical order may be an order that has been fulfilled and/or that was previously placed. Information related to a particular order can include, for example, information related to a user associated with the order (e.g., a passenger that initiates the order, a driver that accepts or rejects the order, a driver to which the order is distributed, etc.), weather information, traffic information, time information, position information, map information, pricing information, information of a route, etc.

The modeling module 320 may be configured to generate a price estimation model to be used to perform price estimation and/or optimization. For example, the modeling module 320 may train an initial price estimation model using one or more machine learning techniques. Exemplary machine learning methods that can be used to train the price estimation model may include a gradient boosting decision tree (GBDT) algorithm, a decision tree algorithm, a Random Forest algorithm, a logistic regression algorithm, a support vector machine (SVM) algorithm, a Naive Bayesian algorithm, a K-a nearest neighbor algorithm, a K-means algorithm, an AdaBoost algorithm, a Neural Networks algorithm, a Markov Chains algorithm, or the like, or any combination thereof.

In some embodiments, the price estimation model can include one or more decision trees. One or more of the decision trees can be a regression tree. The modeling module 320 can associate each of the decision trees with a label. The modeling module 320 can determine a label of a particular decision tree based on outputs of one or more other decision trees. For example, the modeling module 320 can determine the label of the particular decision tree based on one or more residuals associated with the other decision trees. Each of the residuals can represent a difference between an estimated value and an actual value. In some embodiments, a residual can represent a combination of differences between estimated values and actual values associated with the other decision trees.

In some embodiments, the modeling module 320 can determine a first label of a first decision tree of the price estimation model based on a historical actual price. For example, the historical actual price can be used as the first label. The historical actual price may relate to one or more particular users (e.g., passengers), orders, etc. The modeling module 320 can determine one or more first characteristics of the first decision tree based on other historical order information. For example, the first characteristic may be and/or include one or more features of a route, features of one or more links of the route, etc. The modeling module 320 can classify the first characteristics to produce a first estimated price. The first estimated price can correspond to the route. The modeling module 320 can then determine a second label of a second decision tree of the price estimation model based on the first estimated price. For example, the modeling module 320 can determine a residual between the first estimated price and the first actual historical price and use the residual as the second label. The modeling module 320 can also generate second characteristics of the second decision tree based on historical order information. The modeling module 320 can then classify the second characteristics and generate a second estimated price for the second decision tree. The second estimated price may be used to determine a label of a next decision tree. The modeling module 320 can perform the operations described above in an iterative manner to construct the price estimation model. The price estimation model can be constructed based on an optimization algorithm.

In some embodiments, the modeling module 320 can generate one or more price estimation models based on the information received from the obtaining module 310. For example, the price estimation model can be generated based on historical order information, current order information, traffic information, weather information, time information, position information, map information, or the like, or any combination thereof. When a user requests an order, the processor 220 may use the price estimation model to estimate a price for the order.

In some embodiments, the modeling model 320 can generate a price estimation model responsive to a request, periodically, at random times, and/or in any other manner. The price estimation model can be trained online or offline.

The price estimating module 330 may be configured to perform price estimation and/or optimization for a service request requested by a user. For example, the price estimating module 330 can determine one or more estimated prices using the price estimation model(s) generated by the modeling module 320. Each of the estimated prices may be a value or a range of values. More particularly, for example, the price estimating module 330 can generate one or more characteristics of a service request (e.g., a current order). The price estimating module 330 may process the characteristics using the price estimation module(s) to produce an estimated price for the service request. In some embodiments, the characteristics of the service request can include a route. The price estimating module 330 can determine the route based on a first location (e.g., a pickup location) and a second location (e.g., a destination) associated with the service request. The route can be determined using any suitable route planning techniques. The characteristics of the service request can also include information about a user associated with the service request (e.g., a passenger initiating the service order), such as historical order information related to the user. The price estimating module 330 can provide for data about the route, the historical order information related to the user, and/or any other characteristics of the service request as inputs of the price estimation model to produce an estimated price.

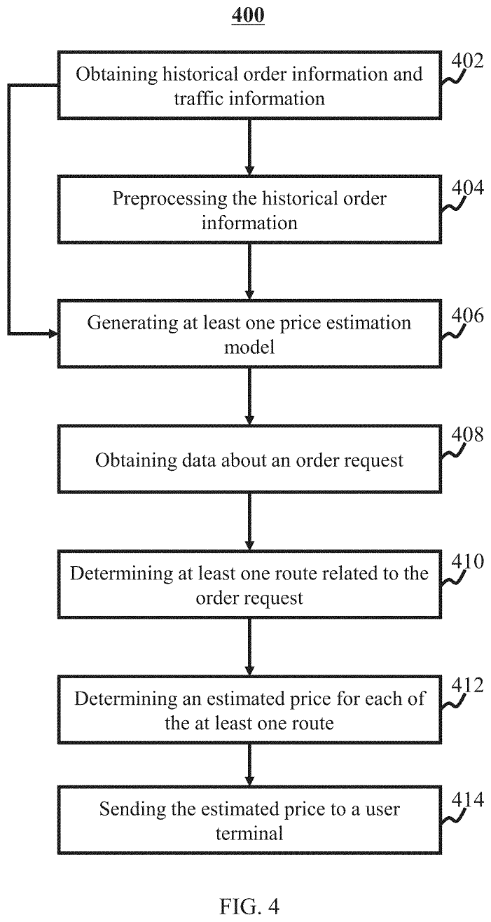

In some embodiments, the modeling module 320 and/or the price estimating module can execute one or more portions of processes 400, 500, and 700 of FIGS. 4, 5, and 7.

The sending module 340 may be configured to send information related to the system 100 to one or more user devices or any other device. For example, the sending module 340 may send estimated prices to the user devices. As another example, the sending module 340 can send data about a price estimation model to the user devices.

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth™, a ZigBee™, a Near Field Communication (NFC), or the like, or any combination thereof. Two or more of the modules may be combined as a single module, and any one of the modules may be divided into two or more units. For example, the obtaining module 310 may be integrated in the sending module 340 as a single module which may both obtain the positioning request from the wireless device and send the default location to the wireless device. As still another example, the modeling module 320 may be divided into three units of a collecting unit, a training unit, and an establishing unit to implement the functions of the modeling module 320, respectively.

FIG. 4 is a flowchart illustrating an exemplary process 400 of price estimation according to some embodiments of the present disclosure. In some embodiments, the process 400 may be implemented by the system 100 illustrated in FIG. 1. For example, the process 400 may be stored in the database 150 and/or the storage (e.g., the ROM 230, the RAM 240, etc.) as a form of instructions, and invoked and/or executed by the server 110 (e.g., the processing engine 112 in the server 110, the processor 220 of the processing engine 112 in the server 110, or one or more components in the processing engine 112 illustrated in FIG. 3).

In 402, the processor 220 may obtain historical order information and traffic information. In some embodiments, the historical order information may include any information related to one or more historical orders (e.g., orders previously placed and/or fulfilled). The historical orders may relate to a location, one or more particular passengers, etc. The location may include a city, a town, a country, a street, one or more portions of a city (e.g., a business district of the city, an area in the city, etc.), or any other location. The processor 220 may be a processor of a server of an online on-demand service platform, such as the system 100. In some embodiments, the historical order information may include any information related to one or more historical order, such as the number of the historical orders, the number of commutes related to the historical orders, the number of orders placed in a particular time period (e.g., during morning and/or evening rush hours), comparison between historical actual prices and historical estimated prices, timing information relating to the orders, rough estimated prices of the historical orders, costs related to the historical orders, fares charged for the historical orders (e.g., a base fare, a cost per minute, a cost per mile, a booking fee, a surcharge, etc.), etc. The timing information relating to the orders may include the time that the orders occurred and the time that the orders spend.

A rough estimated price of an order may be determined based on information related to the order, such as a distance of a ride, timing information relating to the order (e.g., a time corresponding to placement of the order), a travel time of a ride related to the order, a pickup location, a destination, etc. The rough estimation may be determined based on one or more computer-implemented rules. For example, the rough estimated price may be determined by multiplying the distance of the ride by a rate (e.g., a cost per mile). As another example, the rough estimated price may be determined by multiplying the time of the ride by a rate (e.g., a cost per minute). As still another example, the rough estimated price can be determined by adding a surcharge to a fare. The surcharge may include fees relating to distances, fees relating to time, fees for night driving, fees for long distance driving, or the like, or any combination thereof. The fee relating to time may be a fee depending on the time the order cost. For example, the time that the order spent is less than 10 minutes, the fee relating to time may be a fixed price. When the time that the order spent is more than 10 minutes, the fee relating to time may be increased depending on the time that the order cost. The historical information may be stored in the database 150.

In some embodiments, a route from a pick-up location to a destination may include one or more links. Each of the links of the route may correspond to at least a portion of the route. The route may be segmented into multiple links based on one or more predetermined computer-implemented rules. The traffic information may include route information and link information. The route information may include a number of links included in the route, a number of traffic lights included in the route, a number of traffic lights for turning left included in the route, a number of traffic lights for turning right included in the route etc. The link information may include a distance on road of the link, latitudes and longitudes of the endpoints of the link, or any other characteristics of the link that used in the link segmentation of the route, or the like, or any combination thereof. The distance on road may be a distance that is different from a straight-line distance between two locations. The distance on road may be an actual distance that a vehicle can move through. The latitude and longitude of a pick-up location may be obtained from an online digital map database. In some embodiments, the traffic information may be stored in the database 150.

In 404, the processor 220 may preprocess the historical order information.

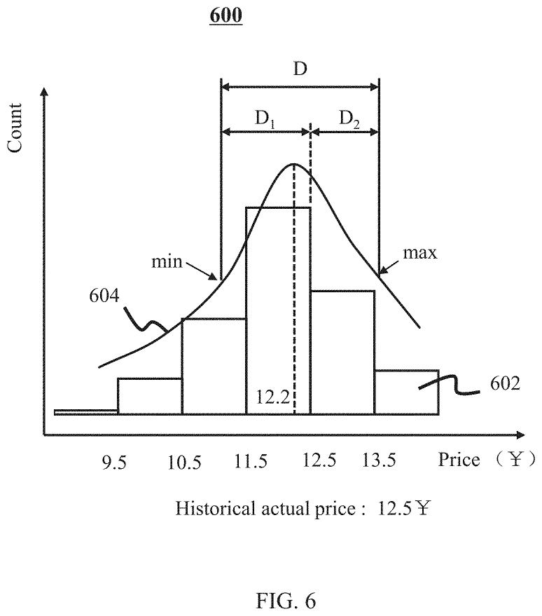

For example, the processor 220 may preprocess the historical order information (e.g., the historical actual prices, the historical estimated prices) to determine rough estimated prices and/or a range of rough estimated prices (also referred to as the “estimated price range”). The estimated price range may include a minimum estimated price and a maximum estimated price. The estimated price range and/or the rough estimated prices may be determined, for example, by performing one or more operations described in connection with FIG. 6 below. In some embodiments, step 404 may be omitted.

In 406, the processor 220 may generate at least one price estimation model based on the. In some embodiments, the price estimation model may be generated using a GBTD algorithm. In some embodiments, the at least one price estimation model may include an estimated price model, a maximum estimated price model, and a minimum estimated price model etc. The price estimation model may be a machine learn model used to estimate the price of an order. In some embodiments, an estimated price value of an order is required. The processor 220 may use one price estimation model to provide an accurate estimated price. In some embodiments, a range of estimated price values of an order is required. The processor 220 may use two price estimation model to provide a minimum estimated price and a maximum estimated price. The minimum estimated price and the estimated estimation price may compose a range of estimated price values of the order.

In 408, the processor 220 may obtain information relating to an order request. The order request can be transmitted from a user terminal. The order request can be initiated by a user. In some embodiments, the information related to the order request may include current order information associate with the user information. The current order information may include a pick-up location, a destination, a pick-up time specified by the user, a special route specified by the user etc. The user information may include a user name, a user identifier, a current location of the user terminal, or the like, or any combination thereof.

In 410, the processor 220 may determine one or more routes related to the order request. In some embodiments, the route(s) may be determined based on the current order information. For example, the processor 220 may determine at least one route from the pick-up location to the destination. In some embodiments, the route(s) may include one or more routes that satisfy one or more conditions. For example, the route(s) may include a route associated with a particular travel time (e.g., the shortest travel time, the second shortest travel time, a travel time that is less than a threshold, etc.). As another example, the route(s) may include a route associated with a particular distance (e.g., the shortest distance, the second shortest distance, etc.).

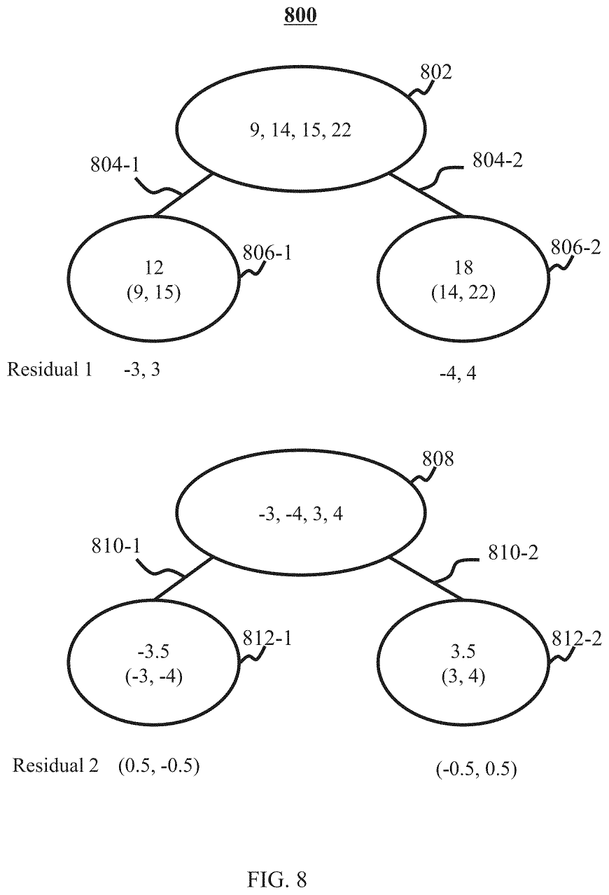

In 412, the processor 220 may determine an estimated price for each of the route(s). In some embodiments, the price estimation for each of the at least one route may be determined by the processor 220 using the price estimation model(s) generated in 406. For example, the processor 220 may extract one or more characteristics of the order request based on the information related to the order request. The characteristics of the order may include, for example, the start location, the destination, a distance between the start location and the destination, the number of traffic lights between a route from the start location and the destination, a time associated with the order request (e.g., a time instant or time period in which the order request is to be fulfilled), weather information, or the like. The processor 220 may determine an estimated price of the order based on the characteristics and the generated price estimation model. For example, the processor 220 may compare the characteristics with classified characteristics included in the price estimation model to determine a classification rule. And based on the classification rule, the processor 220 may provide the estimated price. In some embodiments, the classification rule may be a route that links a group of the classified characteristics. An end of the route may connect to a price. The processor 220 may determine a route for the order and determine the price connected to the route as the estimated price of the order. More details about the route determination may be disclosed elsewhere in the present disclosure (e.g. in the description of FIG. 8). In some embodiments, the price estimation for each of the at least one route may be an estimated price. In some embodiments, the estimated price for each of the at least one route may be an estimated price range.

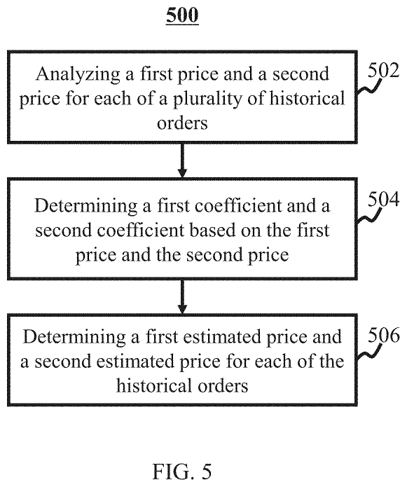

FIG. 5 is a flowchart illustrating an exemplary process 500 of preprocessing the historical order information according to some embodiments of the present disclosure. In some embodiments, the process 500 may be implemented in the system 100 as illustrated in FIG. 1. For example, the process 500 may be stored in the database 150 and/or the storage (e.g., the ROM 230, the RAM 240, etc.) as instructions, and invoked and/or executed by the server 110 (e.g., the processing engine 112 in the server 110, the processor 220 of the processing engine 112 in the server 110, or one or more components in the processing engine 112 illustrated in FIG. 3).

In 502, the processor 220 may determine a first price and a second price for each of a plurality of historical orders. The first price may be an actual price of the historical order (also referred to as the “historical actual price”). The historical actual price may be a price that the user actually paid for the historical order. In some embodiments, one historical actual price may correspond to a plurality of historical orders. A plurality of first prices may be generated for the historical orders. The second price may include a historical estimated price of the historical orders. The historical estimated price may be a rough estimated price. In some embodiments, a plurality of second prices can be generated for the historical orders.

In 504, the processor 220 may determine a first coefficient and a second coefficient based on the first price and the second price. The first coefficient may be used to determine a minimum estimated price based on a historical actual price. The second coefficient may be used to determine a maximum estimated price based on a historical actual price. The first coefficient may be a minimum coefficient. The second coefficient used to determine maximum estimated price may be a maximum coefficient. In some embodiments, one or more of the historical orders may be used to determine the first coefficient and the second coefficient. For different part of historical orders, different first coefficients and second coefficients may be obtained. An average value of the first coefficients and an average value of the second coefficients may be considered as the first coefficient and the second coefficient in 504. For example, the historical orders with historical actual price is 12 ¥ may be used to determine a first group of first coefficients and a second coefficient. The historical orders with historical actual price is 100 ¥ may be used to determine a second group of first coefficient and a second coefficient. An average value of the first coefficient in the first group and the first coefficient in the second group may be considered as the first coefficient in 504. An average value of the second coefficient in the first group and the second coefficient in the second group may be considered as the second coefficient in 504

In 506, the processor 220 may determine a first estimated price and a second estimated price for each of historical orders. The first estimated price may be a minimum rough estimated price of the historical actual price. The second estimated price may be a maximum rough estimated price of the historical actual price. The minimum rough estimated price and the maximum rough estimated price may form a range of rough estimated prices of the historical actual price. In some embodiments, the first estimated price may be determined by multiplying the historical actual price the first coefficient. The second estimated price may be determined by multiplying the historical actual price and the second coefficient.

FIG. 6 is a schematic diagram illustrating an example of a model that can be used to preprocess the historical order information according to some embodiments of the present disclosure. As shown, a statistical histogram 602 and a distribution curve 604 may be used to describe the preprocessing. A part of the historical orders may be analyzed. For example, in this figure, historical orders associated with a particular historical actual price (e.g., 12.5Y) may be analyzed. The horizontal axis in the figure may represent the historical prices and the vertical axis may represent the count of the historical prices. The count of a historical price may refer to numbers of orders that have the historical price. The statistical histogram 602 may represent the distribution of the estimated prices related to the historical orders associated with the historical actual price. The distribution curve 604 may represent the curve fitting of the statistical histogram 602. A range of rough estimated prices may be determined based on the historical actual price and the distribution curve 604. For example, the distribution curve 604 corresponding to the statistical histogram 602 may have a peak price (12.2¥). A range of rough estimated prices D may be determined for determining the first coefficient and the second coefficient. The range of rough estimated prices of the distribution curve 604 may include a minimum price and a maximum price. The first coefficient may be a minimum coefficient determined based on the minimum price and the historical actual price. The second coefficient may be a maximum coefficient determined based on the maximum price and the historical actual price.

In some embodiments, the processor 220 may determine the width D₁ between the minimum price and the historical actual price (also referred to as the first width). The first width may represent a difference between the minimum price and the historical actual price. The processor 220 may determine the width D₂ between the maximum price and the historical actual price (also referred to as the “second width”). The second width may represent a difference between the maximum price and the historical actual price. In some embodiments, the values of the first width and the second width may or may not be the same.

In some embodiments, the range of estimated prices may be determined based on a proportion value. The proportion value may represent a ratio of a covered area under the range of estimated prices to the whole area of the distribution curve 604. Exemplary proportion value may include 20%, 40%, 60%, 70%, 80%, and 90% etc. For example, the proportion value may be determined to be 60%. A plurality of ranges of historical prices may have the proportion value of 60%. The processor 220 may determine the range of historical prices with minimum width as the range of estimated price ranges (such as 11.2 to 13.5). The minimum price and the maximum price may be 11.2 and 13.5.

In some embodiments, the range of estimated prices may has a fixed width (such as 20% of the historical actual price). For example, the historical actual price may be 12.5. The width of the determined price range may be determined as 2.5. A plurality of ranges of historical prices may has the fixed width of 2.5. The processor 220 may determine the range of historical prices with the most estimated prices to be the range of estimated prices, such as 11.1 to 13.6. The minimum estimated price may be 11.1 ¥, and determine the maximum estimated price may be 13.6¥.

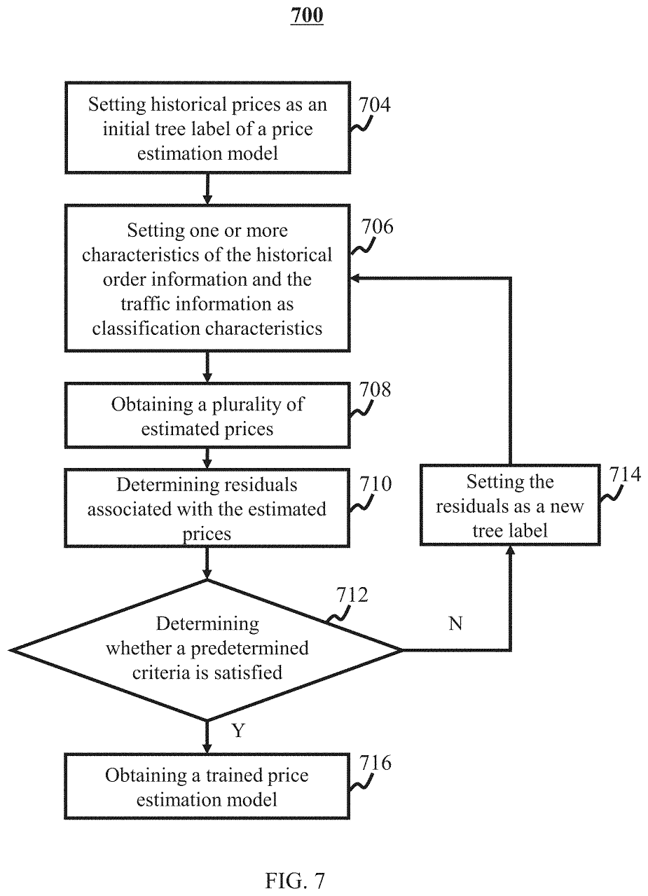

FIG. 7 is a flowchart illustrating an exemplary process 700 of generating a price estimation model according to some embodiments of the present disclosure. In some embodiments, the process 700 may be implemented in the system 100 as illustrated in FIG. 1. When the processor 220 is required to provide an estimated price, it may generate a price estimation model. When the processor 220 is required to provide a range of estimated prices, it may generate two price estimation models using the process 700. One of the price estimation models may be used to determine a minimum estimated price. The other may be used to determine a maximum estimated price. The minimum estimated price and the maximum estimated price may construct the range of estimated prices. When the processor 220 is required to provide an estimated price and a range of estimated prices, it may generate three price estimation models.

In 704, the processor 220 may set one or more historical prices as an initial tree label of the price estimation model. For example, the processor 220 can determine a label of a first decision tree of the price estimation based on the historical prices. In some embodiments, the historical price(s) may be historical actual price(s) obtained based on historical order information. In some embodiments, the historical prices may include the minimum rough estimated prices and/or the maximum rough estimated prices determined in the process 500. In some embodiments in which the historical prices include the minimum rough estimated prices, the processor 220 may generate a price estimation model to provide minimum estimated prices. In some embodiments in which the historical prices include the maximum rough estimated prices, the processor 220 may generate a price estimation model to provide maximum estimated prices. The minimum estimated price and the maximum estimated price may be used to determine a range of estimated prices for each order.

In 706, the processor 220 may set one or more characteristics of the historical order information and the traffic information as classification characteristics.

In some embodiments, the classification characteristics may be used to classify the historical prices included in the initial tree label into a plurality of branches. The branches may be the historical prices satisfied the classification characteristics. In some embodiments, the one or more characteristics of the historical order information may include, a pick-up location, a destination, a distance of the order, an estimated time of the order, etc. In some embodiments, the traffic information may include route information and link information. The route information may include a number of links included in the route, a number of traffic lights included in the route, a number of traffic lights for turning left included in the route, a number of traffic lights for turning right included in the route etc. The link information may include a distance on road of the link, latitudes and longitudes of the endpoints of the link, or any other characteristics of the link that used in the link segmentation of the route, or the like, or any combination thereof. For example, when the classification characteristic is the distance of the order, like 5 kilometers, the orders with the distance of 5 kilometers may be classified into a branch.

In 708, the processor 220 may determine one or more estimated prices. In some embodiments, each of the branches may have classified historical prices that may be used to determine an estimated price. In some embodiments, only one historical price is included in a branch. The one historical price may be considered as the estimated price of the branch. In some embodiments, two or more historical prices may be included in a branch. An average value of the historical prices may be considered as the estimated price. For each of the branches, an estimated price may be determined.

In 710, the processor 220 may determine residuals associated with the estimated prices. In some embodiments, each of the residuals may represent a difference value between one or more of the historical prices and the estimated price of each branch. For example, the historical price may be 12¥ and the estimated price may be 10.5. The processor 220 may determine the residual to be 1.5, as the difference value between the historical price and the estimated price. As another example, the historical price may be 15 and the estimated price may be 17.2. The processor 220 may determine the residual to be −2.2

In 712, the processor 220 may determine whether a predetermined criterion is satisfied. The predetermined criterion may include one or more conditions for concluding process 700. For example, the predetermined criterion may include executing a threshold number of iterations of process 700. More particularly, for example, the processor 220 can determine that the predetermined criterion is satisfied in response to determining that the threshold number of iterations of process 700 have been executed. Alternatively, the processor 220 can determine that the predetermined criterion is not satisfied in response to determining that the threshold number of iterations of process 700 have not been executed.

As another example, the predetermined criterion may include that a value of a lost function is less than a threshold. More particularly, for example, the processor 220 can determine that the predetermined criterion is not satisfied in response to determining that the value of the lost function is less than the threshold. Alternatively, the processor 220 can determine that the predetermined criterion is satisfied in response to determining that the value of the lost function is greater than or equal to the threshold. The loss function may be a function for measuring a deviation between the estimated prices and the historical prices. The loss function may represent a mean value (such as arithmetic mean value, geometric mean value, weighted mean value etc.) of the residuals.

In some embodiments, in response to determining that the predetermined criterion is satisfied, the processor 220 can proceed to step 716. Alternatively, the processor 200 can proceed to step 714 in response to determining that the predetermined criterion is not satisfied.

In 714, the processor 220 may set the residuals as a new tree label. For example, the processor 220 may set the residuals determined in the step 710 as a tree label of a next decision tree of the price estimation model. The new tree label may be used to train the next decision tree of the price estimation model. The processor 220 can then loop back to step 706. For example, the processor 220 can set one or more characteristics of the historical order information and the traffic information as classification characteristics of the next decision tree.

In 716, the processor 220 may obtain a trained price estimation model. The processor 220 can output and/or store the price estimation model trained by performing steps 704-714 as described above. In some embodiments, the trained price estimation model may be used to provide an estimated price in response to an order request. In the trained price estimation model, there may be a plurality of classification trees that may be considered as various links. The characteristics in an order request may be compared with the links to provide an estimated price.

FIG. 8 is a schematic diagram of an example of a data structure for classifying historical orders according to some embodiments of the present disclosure. 802 may represent a first tree label of a price estimation model (e.g., the price estimation model described in connection with FIG. 7). One or more historical prices (e.g., 9, 14, 15, and 22 as illustrated in FIG. 8) may be included in the first tree label. The historical prices may include one or more historical actual prices. In some embodiments, the historical prices may include one or more preprocessed historical prices (e.g., the minimum estimated prices and/or the maximum estimated prices as described above).

804-1 and 804-2 may represent classification characteristics corresponding to the first tree label (e.g., the classification characteristics determined in 704). The classification characteristics may include the historical order information and the traffic information described above. For example, the classification characteristics may include a first distance (e.g., a distance of 3 kilometers) and a second distance (e.g., a distance of 5 kilometers). The historical prices (9, 14, 15, and 22) may be classified into multiple branches based on information related to the historical orders. For example, the orders that correspond to the first distance (e.g., 9 and 15) may be classified into a first branch. As another example, the orders that correspond to the second distance (14 and 22) may be classified into a second branch.

806-1 and 806-2 may represent classified branches of the historical prices based on the classification characteristics 804-1 and 804-2. In some embodiments, the branches of the first tree label may also refer to first sets. A first plurality of average values of the historical prices for the first sets may be determined. An estimated price may be determined for each of the first sets. For example, the estimated price of the branch 806-1 is 12. In some embodiments, the branches may contain two or more historical prices. For example, two or more historical prices in the first tree label 802 may be classified into a branch based on a classification characteristic (e.g., a distance). More particularly, for example, the historical orders classified in the same brank may have the same distance, similar distances, etc. In some embodiments, two distances may be regarded as being similar when a difference between the two distances is not greater than a threshold.

Based on the branches, one or more residuals may be determined. As described above, the value of each of the residuals may be a difference between an estimated price in the branch and a corresponding historical actual price. For example, in branch 806-1, the historical prices are 9 and 15. The corresponding estimated price is 12. Processor 220 may then determine the residuals of branch 806-1 to be −3 and 3.

808 may represent a second tree label of the price estimation model. The residuals of the branches corresponding to the first tree label may be set as the second tree label 808. For example, the residuals of the historical price setting in the second tree label may be −3, −4, 3, and 4. The processor 220 may extract the residuals and set them as the second tree label.

810-1 and 810-2 may represent classification characteristics used to classify the residuals in the second tree label. In some embodiments, classification characteristics 810-1 and 810-2 may be different from the classification characteristics 804-1 and 804-2. For example, classification characteristics 804-1 and 804-2 may be the pick-up location and or distance. The classification characteristics 810-1 and 810-2 for classifying the residuals in the second tree label may be the time that the order spend, the number traffic light, weather etc. As another example, when the classification characteristic 810-1 is number traffic light like 3, the residuals related to the historical order having 3 traffic lights may be classified into a branch.

812-1 and 812-2 may represent branches of the second tree. In some embodiments, the branches of the second tree label may be refer to second sets. A second plurality of average values of the residuals of the first tree label may be determined. The residuals of the second tree label may be determined by the processor 220. The residuals of the second tree label may be determined based on the residuals of the first tree label. For example, the second tree label may include −3, −4, 3, and 4. The average values of the branches 812-1 and 812-2 (the second sets) may be −3.5 and 3.5. Then, the residuals of the second tree label may be 0.5, −0.5, −0.5, and 0.5.

In some embodiments, the predetermined criteria may be satisfied and the price estimation model may be trained by two times of classification as shown in the figure. A relationship between a historical price and an estimated price may be determined. For example, the historical price 9 may be classified in to the branch 812-1. The estimated price of the historical price 9 is a sum of 12 and −3.5 that equal to 8.5. As described above, the route including 804-1 and 810-1 may correspond to a classification rule that can be used to determine the price of 8.5. Similarly, the route including 804-1 and 810-2 may correspond to a classification rule that can be used to determine the price of 15.5. The route including 804-2 and 810-1 may correspond to a classification rule that can be used to determine the price of 14.5. The route including 804-2 and 810-2 may correspond to a classification rule that can be used to determine the price of 21.5. In this case, if an order has the same characteristics of 804-1 and 810-1, the processor 220 may determine the route including 804-1 and 810-1 and determine the estimated price of the order as 8.5.

Embodiments of the disclosure also relate to a computer-readable medium and/or a machine-readable storage medium on which is stored one or more sets of instructions embodying one or more of the methodologies and/or functions descried herein (e.g., instructions executed by the obtaining module 310, the modeling module 320, the price estimating module 330 and the sending module 340). In some embodiments, the computer-readable medium and/or the machine-readable storage medium may include instructions that, when accessed by a processor (or a computing device), cause the processor to perform one or more of the processes and/or methods discussed herein (e.g., one or more processes as described in connection with FIGS. 3-8).

For example, the computer-readable medium and/or the machine-readable storage medium can include instructions that, when assessed by one or more processors implementing the obtaining module 310, cause the processor(s) to obtain information from the user device (e.g., the passenger terminal 130, the driver terminal 140, etc.), the database 150, and/or any other device. In some embodiments, when accessed by the processor(s), the instructions can cause the processor(s) to perform any operation that can be performed by the obtaining module 310 as described in connection with FIG. 3 above.

As another example, the computer-readable medium and/or the machine-readable storage medium can include instructions that, when assessed by one or more processors implementing the modeling module 320, cause the processor(s) to generate one or more price estimation models to be used to perform price estimation and/or optimization. In some embodiments, when accessed by the processor(s), the instructions can cause the processor(s) to perform one or more operations that can be performed by the modeling module 310 as described in connection with FIGS. 3 and 5-8 above.

As still another example, the computer-readable medium and/or the machine-readable storage medium can include instructions that, when assessed by one or more processors implementing the price estimating module 330, cause the processor(s) to perform the price estimation and/or optimization for a service request requested by a user. In some embodiments, when accessed by the processor(s), the instructions can cause the processor(s) to perform one or more operations that can be performed by the price estimating module 330 as described in connection with FIG. 3 above.

As yet another example, the computer-readable medium and/or the machine-readable storage medium can include instructions that, when assessed by one or more processors implementing the sending module 340, cause the processor(s) to send information related to the system 100 to one or more user devices or any other device. In some embodiments, when accessed by the processor(s), the instructions can cause the processor(s) to perform one or more operations that can be performed by the sending module 340 as described in connection with FIG. 3 above.

Here, a computer-readable medium includes any mechanism for storing or transmitting information in a form readable by a machine (e.g., a computer). For example, in some implementations, computer-readable media can be transitory or non-transitory. For example, non-transitory computer-readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer-readable media can include signals on networks, in connectors, conductors, optical fibers, circuits, any suitable media that is fleeting and devoid of any semblance of permanence during transmission, and/or any suitable intangible media.

The disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

1. A system, comprising:
at least one computer-readable storage medium including a set of instructions for providing an on-demand service; and
at least one processor in communication with the computer-readable storage medium, wherein when executing the set of instructions, the at least one processor is directed to:
receive a service request from a user terminal;
determine at least one route for the service request; and
determine an estimated price for the service request based on the at least one route and at least one price estimation model, wherein to determine the estimated price, the processor is further directed to:
extract one or more characteristics of the service request based on the at least one route; and
process the one or more characteristics of the service requests using the at least one price estimation model.

2. The system of claim 1, the processor is further directed to:
obtain historical order information and traffic information related to at least one historical order;
determine a plurality of historical actual prices based on the historical order information;
determine a plurality of historical estimated prices corresponding to the plurality of historical actual prices according to at least one of the traffic information and the historical order information; and
generate the at least one price estimation model based on the plurality of historical actual prices and the plurality of historical estimated prices.

3. The system of claim 1, wherein the estimated price comprises at least one of a price or a price range.

4. The system of claim 1, wherein, to determine the estimated price for the service request, the processor is further directed to process data about the at least one route and at least one historical order related to a user using the at least one price estimation model.

5. The system of claim 2, wherein, to determine the plurality of historical estimated prices corresponding to the plurality of historical actual prices, the processor is further directed to:
classify the plurality of historical actual prices into a plurality of first sets based on at least one of the traffic information and the historical order information;
determine a first plurality of average values of the plurality of historical actual prices for the plurality of first sets; and
determine the plurality of historical estimated prices based on the first plurality of average values.

6. The system of claim 5, wherein, to determine the plurality of historical estimated prices corresponding to the plurality of historical actual prices, the processor is further directed to:
determine a plurality of residuals for the first sets, wherein the plurality of residuals represent differences between the plurality of historical actual prices and the plurality of historical estimated prices; and
classify the plurality of residuals into a plurality of second sets based on at least one of the traffic information or the historical order information.

7. The system of claim 6, wherein, to determine the plurality of historical estimated prices corresponding to the plurality of historical actual prices, the processor is further directed to:
determine a second plurality of average values of the plurality of residuals for the plurality of second sets; and
determine the plurality of historical estimated prices based on the first plurality of average values and the second plurality of average values.

8. The system of claim 2, wherein the at least one processor is further directed to:
analyze a rough estimated price and an actual price for each of a plurality of historical orders related to the historical order information;
determine a minimum coefficient and a maximum coefficient based on the analysis; and
determine a maximum estimated price and a minimum estimated price for each of the historical orders.

9. The system of claim 8, wherein to generate the at least one price estimation model, the at least one processor is further directed to:
generate a first price estimation model based on the minimum estimated price; and
generate a second price estimation model based on the maximum estimated price.

10. The system of claim 1, wherein the traffic information includes at least one of information about at least one traffic light, a distance, a latitude and a longitude of a pick-up location, or a number of links of a route.

11. The system of claim 1, wherein the price estimation model comprises a gradient boosting decision tree (GBDT) model.

12. A method for providing an on-demand service, comprising:
receiving, by a processor, a service request from a user terminal;
determining at least one route for the service request; and
determining an estimated price for the service request based on the at least one route and at least one price estimation model, wherein determining the estimated price includes:
extracting one or more characteristics of the service request based on the at least one route; and
processing the one or more characteristics of the service request using the at least one price estimation model.

13. The method of claim 12, further comprising:
obtaining historical order information and traffic information related to at least one historical order;
determining a plurality of historical actual prices based on the historical order information,
determining a plurality of historical estimated prices corresponding to the plurality of historical actual prices according to at least one of the traffic information and the historical order information; and
generating the at least one price estimation model based on the plurality of historical actual prices and the plurality of historical estimated prices.

14. The method of claim 12, wherein the estimated price comprises at least one of a price or a price range.

15. The method of claim 12, wherein determining the estimated price for the service request comprises processing data about the at least one route and at least one historical order related to a user using the at least one price estimation model.

16. The method of claim 13, wherein determining the plurality of historical estimated prices corresponding to the plurality of historical actual prices comprises:
classifying the plurality of historical actual prices into a plurality of first sets based on at least one of the traffic information and the historical order information;
determining a first plurality of average values of the plurality of historical actual prices for the plurality of first sets; and
determining the plurality of historical estimated prices based on the first plurality of average values.

17. The method of claim 16, wherein determining the plurality of historical estimated prices corresponding to the plurality of historical actual prices further comprises:
determining a plurality of residuals for the first sets, wherein the plurality of residuals represent differences between the plurality of historical actual prices and the plurality of historical estimated prices; and
classifying the plurality of residuals into a plurality of second sets based on at least one of the traffic information or the historical order information.

18. The method of claim 17, wherein determining the plurality of historical estimated prices corresponding to the plurality of historical actual prices further comprises:
determining a second plurality of average values of the plurality of residuals for the plurality of second sets; and
determining the plurality of historical estimated prices based on the first plurality of average values and the second plurality of average values.

19. The method of claim 13, further comprising:
analyzing a rough estimated price and an actual price for each of a plurality of historical orders related to the historical order information;
determining a minimum coefficient and a maximum coefficient based on the analysis; and
determining a maximum estimated price and a minimum estimated price for each of the historical orders.

20. A non-transitory machine-readable storage medium including instructions that, when accessed by at least one processor of an online on-demand service platform, causes the at least one processor to:
receive a service request from a user terminal,
determine at least one route for the service request; and
determine an estimated price for the service request based on the at least one route and at least one price estimation model, wherein to determine the estimated price, the processor is further directed to:
extract one or more characteristics of the service request based on the at least one route; and
process the one or more characteristics of the service request using the at least one price estimation model.
